(19) United States
(12) Patent Application Publication
(10) Pub. No.: US 2023/0176638 A1
(43) Pub. Date: Jun. 8, 2023

(54) ELECTRONIC DEVICE, POWER SWITCHING METHOD AND RELATED ELECTRONIC SYSTEM

(71) Applicant: Wiwynn Corporation, New Taipei City (TW)

(72) Inventors: Hao-Chuan Chu, New Taipei City (TW); Kuo-Hua Tsai, New Taipei City (TW); Che-Wei Lin, New Taipei City (TW); Wei-Chih Chen, New Taipei City (TW); Po-Lin Huang, New Taipei City (TW); Chia-Hui Chen, New Taipei City (TW)

(73) Assignee: Wiwynn Corporation, New Taipei City (TW)

(21) Appl. No.: 17/674,797

(22) Filed: Feb. 17, 2022

(30) Foreign Application Priority Data
Dec. 8, 2021 (TW) 110145830

(51) Int. Cl. G06F 1/26; G06F 1/3206

(52) U.S. Cl. CPC G06F 1/266; G06F 1/263; G06F 1/3206

(57) ABSTRACT

An electronic device for switching a standby power of a motherboard includes a universal serial bus (USB) connector, electrically connected to the motherboard, configured to connect an external device; a device detecting module, coupled to the USB connector, configured to determine a power control signal according to a voltage level of the USB connector; and an output switching control module, coupled to the device detecting module and the USB connector, configured to determine whether to cut off the standby power provided by the motherboard to the USB connector or not according to the power control signal.

### BACKGROUND OF THE INVENTION

### 1. Field of the Invention

The present invention relates to an electronic device, a power switching method and a related electronic system, and more particularly, to an electronic device, a power switching method and a related electronic system capable of switching a power source of a universal serial bus connector.

### 2. Description of the Prior Art

When a conventional universal serial bus (USB) connector implemented on a motherboard of is connected to a power supply device (e.g. a laptop), the power supply device provides a power source for the USB connector. However, when the USB connector of the motherboard of the server is connected to a storage device (e.g. a USB portable hard drive), the motherboard cannot provide power to the USB connector, and is unable to effectively support the USB portable hard drive. That is, the conventional USB connector of the motherboard of the server cannot support different external devices (i.e. power supply devices and storage devices).

Therefore, improvements are necessary to the conventional technique.

### SUMMARY OF THE INVENTION

In light of this, the present invention provides an electronic device, a power switching method and a related electronic system, which switches a power source of a universal serial bus connector.

An embodiment of the present invention discloses an electronic device for switching a standby power of a motherboard, comprises a universal serial bus (USB) connector, electrically connected to the motherboard, configured to connect an external device; a device detecting module, coupled to the USB connector, configured to determine a power control signal according to a voltage level of the USB connector; and an output switching control module, coupled to the device detecting module and the USB connector, configured to determine whether to cut off the standby power provided by the motherboard to the USB connector or not according to the power control signal.

Another embodiment of the present invention discloses a power switching method, for a motherboard of an electronic device having a universal serial bus (USB) connector, a device detecting module and an output switching control module, wherein the power switching method comprises determining a power control signal according to a voltage level of the USB connector; and determining whether to cut off the standby power provided by the motherboard to the USB connector or not according to the power control signal.

Another embodiment of the present invention discloses an electronic system, comprises a central processing processor (CPU); a platform controller hub (PCH), coupled to the CPU; and a motherboard, coupled to the PCH, configured to provide a standby power; comprises an electronic device, implemented on the motherboard, for switching the standby power of the motherboard, comprising: a universal serial bus (USB) connector, electrically connected to the motherboard, configured to connect an external device; a device detecting module, coupled to the USB connector, configured to determine a power control signal according to a voltage level of the USB connector; and an output switching control module, coupled to the device detecting module and the USB connector, configured to determine whether to cut off the standby power provided by the motherboard to the USB connector or not according to the power control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the present invention.

FIG. 2 is a schematic diagram of the electronic device according to an embodiment of the present invention.

FIG. 3 is a circuit diagram of a device detecting module according to an embodiment of the present invention.

FIGS. 4 and 5 are circuit diagrams of an output switching control module according to an embodiment of the present invention.

FIG. 6 is a schematic diagram of an electronic system according to an embodiment of the present invention.

FIG. 7 is a schematic diagram of a power switching method according to an embodiment of the present invention.

### DETAILED DESCRIPTION

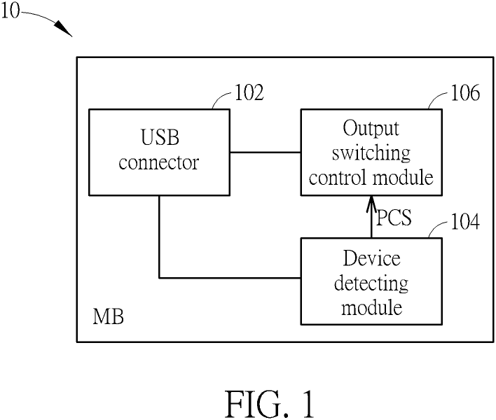

Please refer to FIG. 1, which is a schematic diagram of an electronic device 10 according to an embodiment of the present invention. The electronic device 10 may be implemented on a motherboard MB of a server for switching a standby power of the motherboard MB. The electronic device 10 includes a universal serial bus (USB) connector 102, a device detecting module 104 and an output switching control module 106. The USB connector 102 may be a universal serial bus type-C (USB Type-C) connector for connecting an external device, wherein the external device may be a power supply device or a storage device, e.g. a laptop or a USB portable hard drive. The device detecting module 104 is coupled to the USB connector 102 for determining a power control signal PCS according to a voltage level of the USB connector 102. The output switching control module 106 is coupled to the device detecting module 104 and the USB connector 102, for determining whether to cut off the standby power provided by the motherboard MB to the USB connector 102 or not according to the power control signal PCS. Therefore, when the USB connector 102 of the electronic device 10 is not connected to any device or when the USB connector 102 of the electronic device 10 is connected to the USB portable hard drive, the USB connector 102 may provide a 5 V the standby power for the USB portable hard drive; when the USB connector 102 of the electronic device 10 is connected to the laptop, the electronic device 10 cuts off the 5 V the standby power provided by the motherboard MB to prevent the USB connector 102 from receiving two different power sources, since the laptop will provide the power source for the USB connector 102.

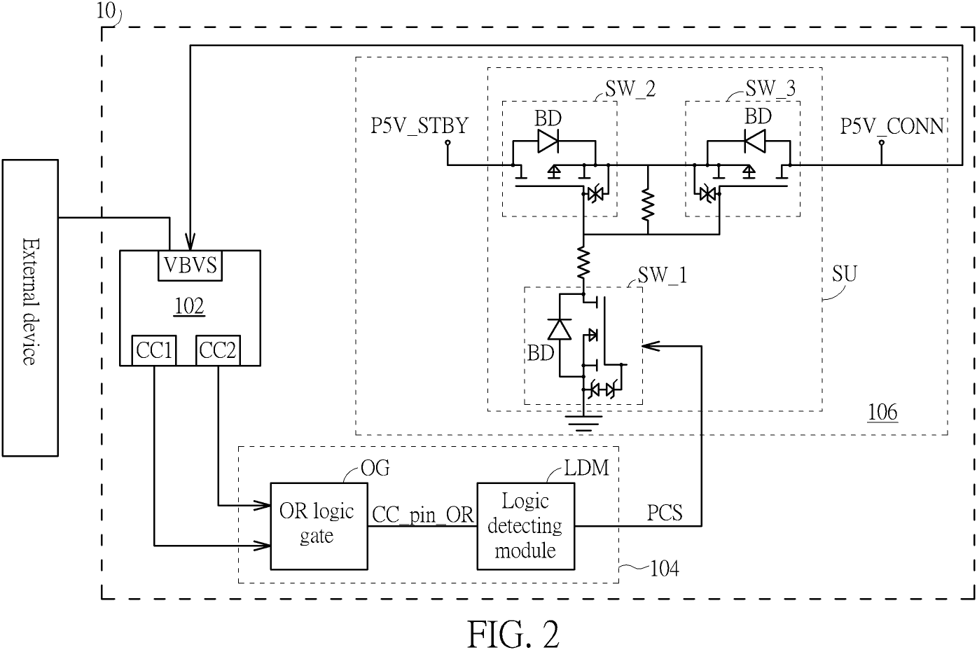

Please refer to FIG. 2, which is a schematic diagram of the electronic device 10 according to an embodiment of the present invention. In an embodiment, the device detecting module 104 may be implemented by an OR logic gate OG and a logic detecting module LDM. The OR logic gate OG and the logic detecting module LDM may determine the power control signal PCS according to a voltage level of configuration pin CC1 or CC2 of the USB connector 102.

For example, when the USB connector 102 of the electronic device 10 is not connected to any device or connected to the USB portable hard drive, the motherboard MB pulls one of the voltage level of the configuration pin CC1 or CC2 to zero volt (V), and a default voltage level of a signal CC_pin_OR output by the OR logic gate OG is at a low voltage level (e.g. a binary 0 or a logic false). In this way, the device detecting module 104 may determine the power control signal PCS accordingly to conduct the 5 V standby power P5V_STBY of the motherboard MB to the USB connector 102.

When the USB connector 102 of the electronic device 10 is connected to the laptop, the configuration pin CC1 or CC2 is affected by a busbar voltage VBUS of the laptop, and the voltage level of the configuration pin CC1 or CC2 is slightly increased to 0.4 V to 0.9 V. In this regard, the device detecting module 104 may determine the power control signal PCS accordingly to cut off the 5 V standby power P5V_STBY of the motherboard MB to the USB connector 102. More specifically, when the laptop and the USB connector 102 are connected by a type-A-to-C power cable, the voltage level of the configuration pin CC1 or CC2 is around 0.4 V; when the laptop and the USB connector 102 are connected by a type-C power cable, the voltage level of the configuration pin CC1 or CC2 is around 0.9 V.

Therefore, a threshold of the logic detecting module LDM of the electronic device 10 may be set as 0.2 V. When the voltage level of the configuration pin CC1 or CC2 is higher than the threshold (i.e. 0.2 V), the logic detecting module LDM outputs the power control signal PCS at the low voltage level to the output switching control module 106.

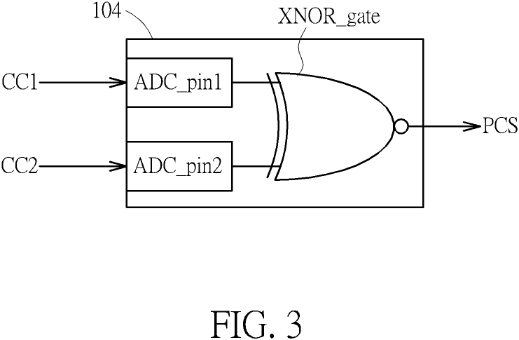

In an embodiment, the device detecting module 104 according to an embodiment of the present invention may be implemented by a microcontroller, e.g. a bridge IC, as shown in FIG. 3. FIG. 3 is a circuit diagram of a device detecting module 104 according to an embodiment of the present invention. The device detecting module 104 includes analog-to-digital conversion units ADC_pin_1, ADC_pin_2 and an XNOR gate XNOR_gate. When both of the configuration pins CC1, CC2 are at the low voltage level, the XNOR gate XNOR_gate outputs the power control signal PCS at a high voltage level (e.g. a binary 1 or a logic true) to the output switching control module 106; when one of the configuration pins CC1, CC2 is at the high voltage level, the XNOR gate XNOR_gate outputs the power control signal PCS at the low voltage level to the output switching control module 106.

In an embodiment, the output switching control module 106 includes a switch unit SU for conducting or cutting off the 5 V standby power P5V_STBY of the motherboard MB to the USB connector 102 according to the power control signal PCS. In an embodiment, the switch unit SU may include a first switch element SW_1, a second switch element SW_2 and a third switch element SW_3. The first switch element SW_1 is conducted or cut off according to the power control signal PCS of the device detecting module 104. The second switch element SW_2 and the third switch element SW_3 are coupled to the first switch element SW_1, and conduct or cut off the 5 V standby power P5V_STBY of the motherboard MB to the USB connector 102 when the first switch element SW_1 is conducted.

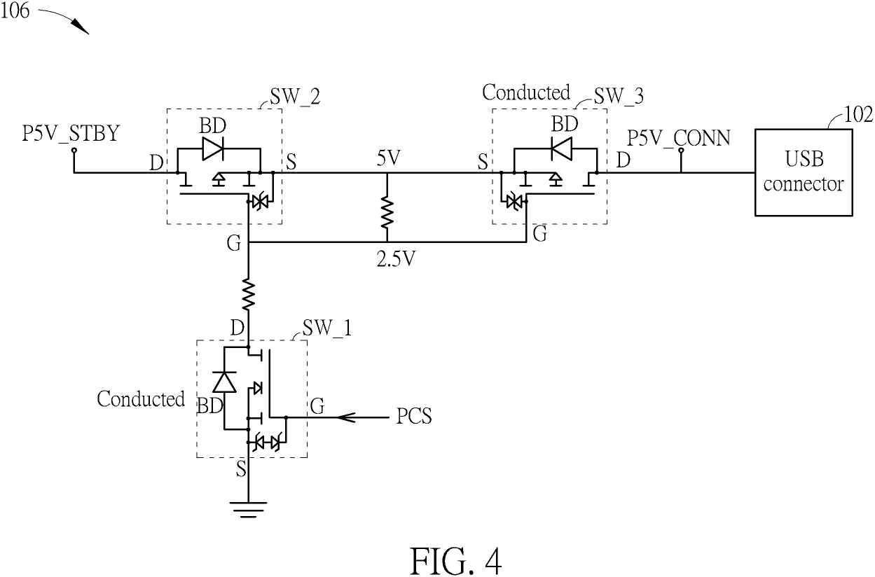

Please refer to FIG. 4, which is a circuit diagram of the output switching control module 106 according to an embodiment of the present invention. In this example, the first switch element SW_1, the second switch element SW_2 and the third switch element SW_3 may be metal-oxide-semiconductor field-effect transistors (MOSFET), the first switch element SW_1 is an N-type MOSFET, the second switch element SW_2 and the third switch element SW_3 are P-type MOSFETs.

A gate G of the first switch element SW_1 is configured to receive the power control signal PCS from the device detecting module 104, when the power control signal PCS is at the high voltage level (i.e. the USB connector 102 of the electronic device 10 is connected to the USB portable hard drive or the USB connector 102 of the electronic device 10 is not connected to any device), the first switch element SW_1 is conducted, the 5 V standby power P5V_STBY of the motherboard MB flows to a source S of the second switch element SW_2 via a body diode BD of the second switch element SW_2. Meanwhile, since the first switch element SW_1 is conducted, a voltage of a gate G of the second switch element SW_2 and the third switch element SW_3 are 2.5 V, a voltage Vgs of the third switch element SW_3 is -2.5 V and the third switch element SW_3 is conducted, such that the 5 V standby power P5V_STBY of the motherboard MB flows to the USB connector 102.

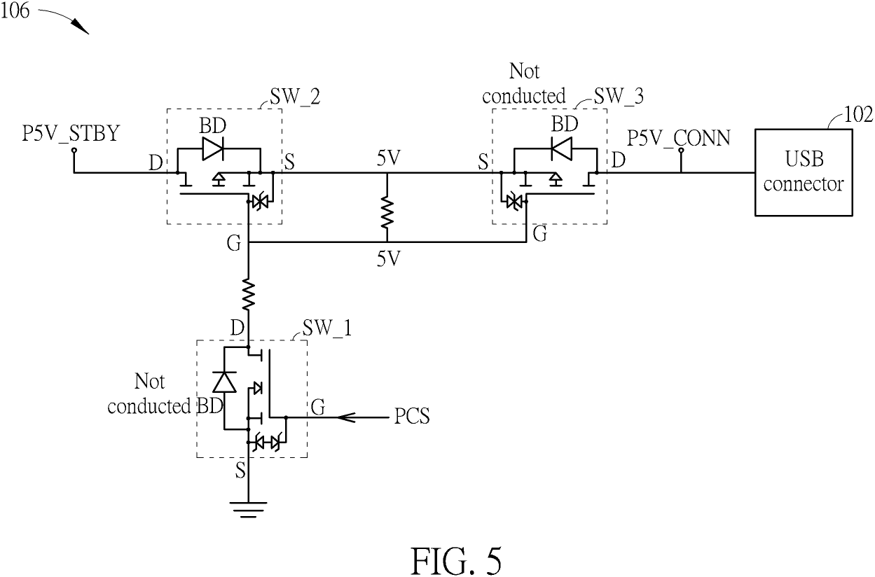

Please refer to FIG. 5, which is a circuit diagram of the output switching control module 106 when the first switch element SW_1 is not conducted according to an embodiment of the present invention. When the power control signal PCS is at the low voltage level (i.e. the USB connector 102 of the electronic device 10 is connected to the laptop), the first switch element SW_1 is not conducted, the voltage of the gate G of the second switch element SW_2 and the gate G of the third switch element SW_3 are 5 V, the voltage Vgs of the third switch element SW_3 is 0V and the third switch element SW_3 is not conducted, such that the 5 V standby power P5V_STBY of the motherboard MB does not flow to the USB connector 102, and the 5 V voltage of the USB connector 102 is provided by the laptop.

Therefore, the electronic device 10 according to an embodiment of the present invention switches the power source of the USB connector 102 to prevent from receiving two different power sources simultaneously.

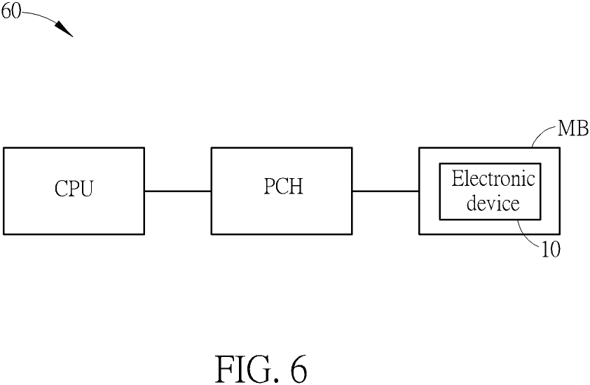

Please refer to FIG. 6, which is a schematic diagram of an electronic system 60 according to an embodiment of the present invention. The computer system 60 includes a central processing unit CPU, a platform controller hub PCH and the electronic device 10, wherein the computer system 60 may provide the power source for the motherboard MB of the electronic device 10 via the platform controller hub PCH to the USB connector 102.

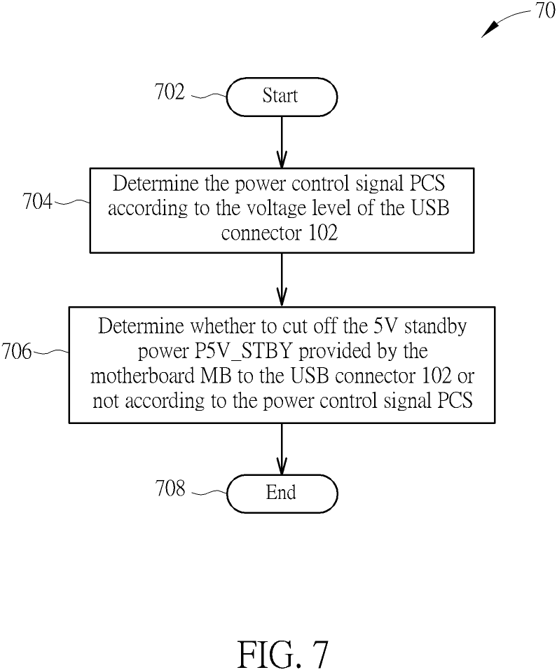

An operation of switching the power source of the motherboard MB of the electronic device 10 may be summarized by a power switching method 70, as shown in FIG. 7. The power switching method 70 includes the following steps:
Step 702: Start.
Step 704: Determine the power control signal PCS according to the voltage level of the USB connector 102;
Step 706: Determine whether to cut off the 5 V standby power P5V_STBY provided by the motherboard MB to the USB connector 102 or not according to the power control signal PCS;
Step 708: End.

Further details regarding the operation of the power switching method 70 are provided by the embodiments of the electronic device 10, and are not narrated here for brevity.

Notably, the embodiments illustrate a concept of the present invention. Those skilled in the art may make proper modifications to the present invention according to different requirements. For example, the circuits for implementing the device detecting module and the output switching control module, the threshold for determining the voltage level of the configuration pins and the allocation method and number of the switch elements of the switch unit. All these modifications belong to the scope of the present invention.

In summary, the present invention provides an electronic device, a power switching method and a related electronic system, which switches a power source of a universal serial bus (USB) connector to prevent the USB connector from receiving two different power sources at the same time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device for switching a standby power of a motherboard, comprising:
a universal serial bus (USB) connector, electrically connected to the motherboard, configured to connect an external device;
a device detecting module, coupled to the USB connector, configured to determine a power control signal according to a voltage level of the USB connector; and
an output switching control module, coupled to the device detecting module and the USB connector, configured to determine whether to cut off the standby power provided by the motherboard to the USB connector or not according to the power control signal.

2. The electronic device of claim 1, wherein the device detecting module is configured to determine the power control signal according to voltage levels of a plurality of configuration pins of the USB connector.

3. The electronic device of claim 2, wherein when the external device coupled to the USB connector is a storage device, or the USB connector is not connected to any device, a voltage level of one of the plurality of configuration pins is zero, such that the device detecting module accordingly determines the power control signal to output the standby power of the motherboard to the USB connector.

4. The electronic device of claim 2, wherein when the external device coupled to the USB connector is a power supply device, a voltage level of one of the plurality of configuration pins is increased by a busbar voltage of the USB connector, such that the device detecting module accordingly determines the power control signal to cut off the standby power of the motherboard to the USB connector.

5. The electronic device of claim 1, wherein the output switching control module comprises:
a switch unit, configured to conduct or cut off the standby power of the motherboard to the USB connector according to the power control signal.

6. The electronic device of claim 5, wherein the switch unit includes at least a switch element.

7. A power switching method, for a motherboard of an electronic device having a universal serial bus (USB) connector, a device detecting module and an output switching control module, wherein the power switching method comprising:
determining a power control signal according to a voltage level of the USB connector; and
determining whether to cut off the standby power provided by the motherboard to the USB connector or not according to the power control signal.

8. The power switching method of claim 7, wherein the device detecting module is configured to determine the power control signal according to voltage levels of a plurality of configuration pins of the USB connector.

9. The power switching method of claim 8, wherein when the external device coupled to the USB connector is a storage device, or the USB connector is not connected to any device, a voltage level of one of the plurality of configuration pins is zero, such that the device detecting module accordingly determines the power control signal to output the standby power of the motherboard to the USB connector.

10. The power switching method of claim 8, wherein when the external device coupled to the USB connector is a power supply device, a voltage level of one of the plurality of configuration pins is increased by a busbar voltage of the USB connector, such that the device detecting module accordingly determines the power control signal to cut off the standby power of the motherboard to the USB connector.

11. The power switching method of claim 7, wherein the output switching control module includes a switch unit for conducting or cutting off the standby power of the motherboard to the USB connector according to the power control signal.

12. The power switching method of claim 11, wherein the switch unit includes at least a switch element.

13. An electronic system, comprising:
a central processing processor (CPU);
a platform controller hub (PCH), coupled to the CPU; and
a motherboard, coupled to the PCH, configured to provide a standby power; comprising:
an electronic device, implemented on the motherboard, for switching the standby power of the motherboard, comprising:
a universal serial bus (USB) connector, electrically connected to the motherboard, configured to connect an external device;
a device detecting module, coupled to the USB connector, configured to determine a power control signal according to a voltage level of the USB connector; and
an output switching control module, coupled to the device detecting module and the USB connector, configured to determine whether to cut off the standby power provided by the motherboard to the USB connector or not according to the power control signal.

14. The electronic system of claim 13, wherein the device detecting module is configured to determine the power control signal according to voltage levels of a plurality of configuration pins of the USB connector.

15. The electronic system of claim 14, wherein when the external device coupled to the USB connector is a storage device, or the USB connector is not connected to any device, a voltage level of one of the plurality of configuration pins is zero, such that the device detecting module accordingly determines the power control signal to output the standby power of the motherboard to the USB connector.

16. The electronic system of claim 14, wherein when the external device coupled to the USB connector is a power supply device, a voltage level of one of the plurality of configuration pins is increased by a busbar voltage of the USB connector, such that the device detecting module accordingly determines the power control signal to cut off the standby power of the motherboard to the USB connector.

17. The electronic system of claim 13, wherein the output switching control module comprises:
a switch unit, configured to conduct or cut off the standby power of the motherboard to the USB connector according to the power control signal.

18. The electronic system of claim 17, wherein the switch unit includes at least a switch element.
